(19) United States
(12) Patent Application Publication
(10) Pub. No.: US 2005/0251662 A1
(43) Pub. Date: Nov. 10, 2005

(54) Secondary register file mechanism for virtual multithreading

(76) Inventor: Nicholas G. Samra, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/830,589

(22) Filed: Apr. 22, 2004

(51) Int. Cl. G06F 9/44

(52) U.S. Cl. 712/228

(57) ABSTRACT

Method, apparatus and system embodiments provide one or more secondary register files to store register values for inactive virtual software threads in a virtual multithreading environment. A separate secondary register file may maintain logical register values for each inactive virtual thread.

### BACKGROUND

1. Technical Field

The present disclosure relates generally to information processing systems and, more specifically, to a mechanism that maintains the register values for inactive software threads in storage area separate from the primary physical register file.

2. Background Art

In order to increase performance of information processing systems, such as those that include microprocessors, both hardware and software techniques have been employed. On the hardware side, microprocessor design approaches to improve microprocessor performance have included increased clock speeds, pipelining, branch prediction, super-scalar execution, out-of-order execution, and caches. Many such approaches have led to increased transistor count, and have even, in some instances, resulted in transistor count increasing at a rate greater than the rate of improved performance.

Rather than seek to increase performance through additional transistors, other performance enhancements involve software techniques. One software approach that has been employed to improve processor performance is known as “multithreading.” In software multithreading, an instruction stream may be split into multiple instruction streams that can be executed in parallel. Alternatively, independent software threads may be executed concurrently.

In one approach, known as time-slice multithreading or time-multiplex (“TMUX”) multithreading, a single processor switches between threads after a fixed period of time. In still another approach, a single processor switches between threads upon occurrence of a trigger event, such as a long latency cache miss. In this latter approach, known as switch-on-event multithreading (“SoEMT”), only one thread, at most, is active at a given time.

Increasingly, multithreading is supported in hardware. For instance, in one approach, processors in a multi-processor system, such as a chip multiprocessor (“CMP”) system, may each act on one of the multiple threads concurrently. In another approach, referred to as simultaneous multithreading (“SMT”), a single physical processor is made to appear as multiple logical processors to operating systems and user programs. For SMT, multiple threads can be active and execute concurrently on a single processor without switching. That is, each logical processor maintains a complete set of the architecture state, but many other resources of the physical processor, such as caches, execution units, branch predictors control logic and buses are shared. For SMT, the instructions from multiple software threads may thus execute concurrently on each logical processor.

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of an apparatus, system and method for a mechanism that maintains register values for inactive SoEMT software threads in a secondary register file.

FIG. 1 is a block diagram of at least one embodiment of a multi-threaded processor that includes a secondary register file.

FIG. 2 is a timing diagram that illustrates a sample thread switch sequence, according to at least one embodiment.

FIG. 3 is a flowchart illustrating at least one embodiment of a method for generating and renaming a register swap micro-operation.

FIGS. 4 and 5 are block data flow diagrams that illustrate at least one embodiment for renaming an example register swap micro-operation.

FIG. 6 is a flowchart illustrating at least one embodiment of a method for swapping register values for dozing and waking virtual threads between primary and secondary register storage areas.

FIG. 7 is a block data flow diagram illustrating at least one embodiment of a method for executing an example register swap micro-operation.

FIG. 8 is a block diagram illustrating at least one embodiment of a processing system capable of utilizing disclosed techniques.

### DETAILED DESCRIPTION

In the following description, numerous specific details such as processor types, multithreading approaches, microarchitectural structures, architectural register names, and thread switching methodology have been set forth to provide a more thorough understanding of embodiments of the present invention. It will be appreciated, however, by one skilled in the art that embodiments of the invention may be practiced without such specific details. Additionally, some well-known structures, circuits, and the like have not been shown in detail to avoid unnecessarily obscuring the embodiments.

A particular hybrid of multithreading approaches is disclosed herein. Particularly, a combination of SoEMT and SMT multithreading approaches is referred to herein as a “Virtual Multithreading” approach. For SMT, two or more software threads may run concurrently in separate logical contexts. For SoEMT, only one of multiple software threads is active in a logical context at any given time. These two approaches are combined in Virtual Multithreading. In Virtual Multithreading, each of two or more logical contexts supports two or more SoEMT software threads, referred to as “virtual threads.”

For example, three virtual software threads may run on an SMT processor that supports two separate logical thread contexts. Only two of the thread virtual software threads are active at any given time; one on each logical processor. Any of the three software threads may begin running, and then go into an inactive state upon occurrence of an SoEMT trigger event. The inactive state may be referred to herein as a “sleep” state, although the term “sleep state” is not intended to be limiting as used herein. “Sleep state” thus is intended to encompass, generally, the inactive state for an SoEMT thread. An inactive virtual thread may sometimes be referred to herein as a “sleeping” thread.

Because expiration of a TMUX multithreading timer may be considered a type of SoEMT trigger event, the use of the term “SoEMT” with respect to the embodiments described herein is intended to encompass multithreading wherein thread switches are performed upon the expiration of a TMUX timer, as well as upon other types of trigger events, such as a long latency cache miss, execution of a particular instruction type, and the like.

When resumed, a sleeping software thread need not resume in the same logical context in which it originally began execution—it may resume either in the same logical context or in another logical context. In other words, a virtual software thread may switch back and forth among logical contexts over time. Disclosed herein is a mechanism to efficiently maintain register values for multiple active and inactive software threads in order to support the hybrid Virtual Multithreading (VMT) environment.

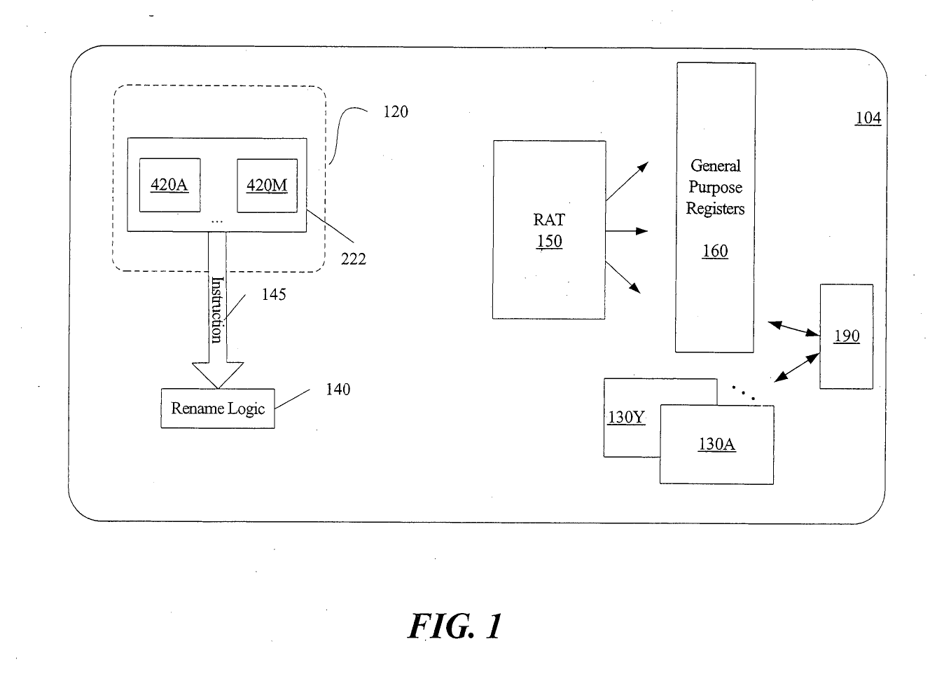

FIG. 1 is a block diagram illustrating a processor 104 capable of performing embodiments of disclosed techniques to maintain register values for a plurality of VMT software threads. The processor 104 may include one or more execution units 109 to perform operations indicated by instructions and/or micro-operations (collectively referred to as “instructions 145”) provided by a front end 120.

The processor 104 thus may include a front end 120 that prefetches instructions that are likely to be executed. For at least one embodiment, the front end 120 includes a fetch/decode unit 222 that includes a logically independent sequencer 420A-420M for each of two or more physical thread contexts. The physical thread contexts may also be interchangeably referred to herein as “logical processors” and/or “physical threads.” The single physical fetch/decode unit 222 thus includes a plurality of logically independent sequencers 420A-420M, each corresponding to one of M physical threads. The front end 120 delivers the fetched instructions 145 to later stages of an execution pipeline.

For at least one embodiment, the processor 104 supports virtual multithreading in that the M physical threads may support N virtual software threads, wherein N>M. For at least one such embodiment, only one of the N virtual software threads is active on a physical thread at any given time. In other words, only M of the N software threads may be running at any given time, while the other of the N−M software threads are inactive.

For at least one embodiment, the front end 120 is to provide special register swap instructions that it has either generated or has obtained from memory or software. For at least one embodiment, these register swap instructions are micro-operations. In other words, the register swap instructions may be understood and executed by an execution unit 190 but are not architecturally visible instructions. For other embodiments, of course, the register swap instructions may be architecturally visible instructions.

FIG. 1 illustrates that at least one embodiment of the processor 104 includes one or elements 130, 140, 150 that may be utilized to perform register renaming. Register renaming is a mechanism to remap (rename) logical registers to physical registers in order to increase the number of instructions that a superscalar processor can issue in parallel. Register renaming is described in further detail below.

While FIG. 1 illustrates that a fetched instruction 145 is provided to the rename logic 140, one of skill in the art will recognize that other intervening pipeline stages may be performed without departing from the functionality of the embodiments described herein. For example, the instruction 145 may be an architecturally visible instruction that is subsequently decoded into micro-operations and/or stored in a micro-operation queue (not shown). As used herein, the term “instruction” in intended to encompass micro-operations and other units of work that can be understood and operated upon by a execution unit 190 of a processor 104.

Regarding renaming, compiled or assembled software instructions reference the relatively small set of logical registers defined in the instruction set for a target processor. Superscalar processors attempt to exploit instruction level parallelism by issuing multiple instructions in parallel, thus improving performance. The instruction set for a processor commonly includes a limited number of available logical registers. As a result, the same logical register is often used in compiled code to represent many different variables, although a logical register represents only one variable at any given time.

However, the processor may provide a larger number of actual registers to store register values. This storage area is commonly a set of physical registers referred to as a physical register file 160. For example, a particular processor architecture might specify only eight (8) general-use registers while the processor 104 may provide 128 physical general-use registers in the physical register file 160.

The register rename logic 140 is to map each occurrence of the general use logical registers in an instruction stream to one of the physical registers 160. The renaming logic 140 may utilize a rename table 150 to keep track of the latest version of each architectural (logical) register to tell the next instruction(s) where (that is, from which physical register 160) to get its input operands. For at least one embodiment, the rename table 150 is referred to as a register alias table (RAT). For at least one embodiment, each logical processor 420A-420M may maintain and track its own architecture state and therefore may maintain its own RAT 150, or may be allocated a partitioned portion of a global RAT 150.

Commonly, the general-purpose register file 160 is shared among logical processors within a processor 104. This scheme may result in inefficient utilization of the register file 160 by sleeping virtual threads. If all logical registers for each of the virtual threads is renamed to a register in the general purpose register file 160, then the various virtual threads, even the inactive virtual threads, may utilize a relatively large number of the available physical registers 160. In addition to being inefficient such approach may, for at least some embodiments, lower the overall performance of the processor 104. Therefore, one of the challenges for a processor 104 that supports virtual multithreading and utilizes renaming is the storing and tracking of general purpose register values for inactive virtual threads.

FIG. 1 illustrates that one or more secondary storage areas 130, referred to herein as secondary register files, may be utilized to address this challenge. The secondary register files 130 may be utilized to store the values for logical registers for inactive virtual threads, allowing the main physical register file 160 to contain only register values for active virtual threads. For at least one embodiment, the number (Y) of secondary register files 130 corresponds to the maximum number of virtual threads that may be inactive at any point in time. For example, a processor 104 that can run four virtual threads on two physical threads may include two secondary register files 130, each to accommodate one of two inactive virtual threads. That is, for a processor 104 that supports N virtual threads on M physical threads, Y may be calculated as N−M.

Due to the dynamic nature of virtual multithreading, a particular secondary register file 130 is not allocated to any particular virtual thread, but may be utilized to hold register values for any virtual thread that happens to be inactive at a given time.

The number of entries in each secondary register file 130 may be equivalent to the number of architectural registers defined for the processor 104. For the above example of an eight-register architecture, for instance, each secondary register file 130 may include eight entries, one for each general-purpose logical register. In some embodiments, therefore, the secondary register file 130 is quite a bit smaller than the general-purpose register file 160. Also, the secondary register files 130 may each be implemented with a single read port and a single write port. Secondary register files 130 may be implemented, for example, as arrays having a single read and write port. This implementation requires less overhead than a register file 160 implemented with multiple read and write ports. One should note that the example of an array data structure for the secondary register files 130 is given for purposes of illustration only, and should not be taken to be limiting. The secondary register files 130 may be implemented as any appropriate storage structure, including, for instance, an array (including a memory array or register array), a latch or group of latches, a register, or a buffer.

The read and write ports of each register secondary register file 130 may be accessed by an execution unit 190, responsive to a register swap micro-operation. When execution unit 190 executes the micro-operation, the execution unit 190 is directed to place a register value from one of the secondary register files 130, rather than from the general register file 160, into the destination register. Such direction may be facilitated, at least in part, by action of the rename logic 140, as is discussed below.

The register swap micro-operation may be generated by control logic (not shown). For at least one other embodiment, the register swap micro-operation may be retrieved from a memory location, such as a microcode read only memory (ROM). For at least one other embodiment, the register swap micro-operation may be generated by software.

The register swap micro-operation may, for at least one embodiment, include a value that indicates which entry of the secondary register file 130 is to be accessed in order for the execution unit 190 to obtain the desired register value. For at least one embodiment, this value may be implicit. That is, the logical register identifier (provided as a source operand) may be utilized as the index into the secondary register file 130.

For an embodiment having more than one secondary register file 130, such as the embodiment illustrated in FIG. 1, the register swap micro-operation may further include an indicator to identify the particular secondary register file 130 to be accessed by the execution unit 190. For at least one embodiment, this indicator, in effect, identifies the secondary register file 130 for the formerly sleeping thread that is being activated as the result of a register swap operation.

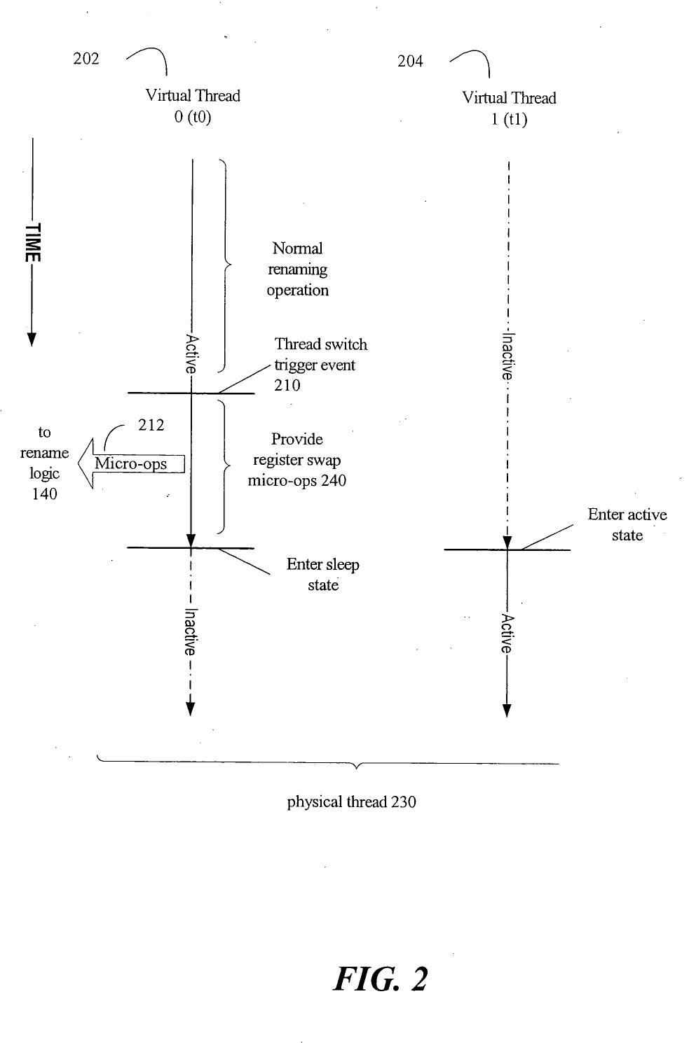

Reference is now made to FIG. 2 to discuss an illustrative thread switch example. For purposes of example, FIG. 2 illustrates that a thread switch event 210 triggers a thread switch operation such that a first, active, virtual thread 202 becomes inactive (a “dozing” thread) and a second, sleeping, virtual thread 204 becomes active (a “waking” thread) for a given physical thread 230. For ease of reference, virtual thread 0 202 is referred to herein as “t0” and virtual thread 1 204 is referred to herein as “t1”.

The point in the t0 instruction stream where thread 0 202 will stop executing instructions (until re-activated) is referred to herein as the “swap point.” FIG. 2 illustrates that, prior to the trigger event, the active virtual thread t0 202 completes renaming of all instructions that are older, in relation to program order, than the swap point in the thread 0 202 instruction stream.

In response to detection of the thread switch trigger event 210, the front end 120 (FIG. 1) may produce one or more register swap micro-operations 212. For at least one embodiment, the register swap micro-operations 212 have the format illustrated in Table 1, below.

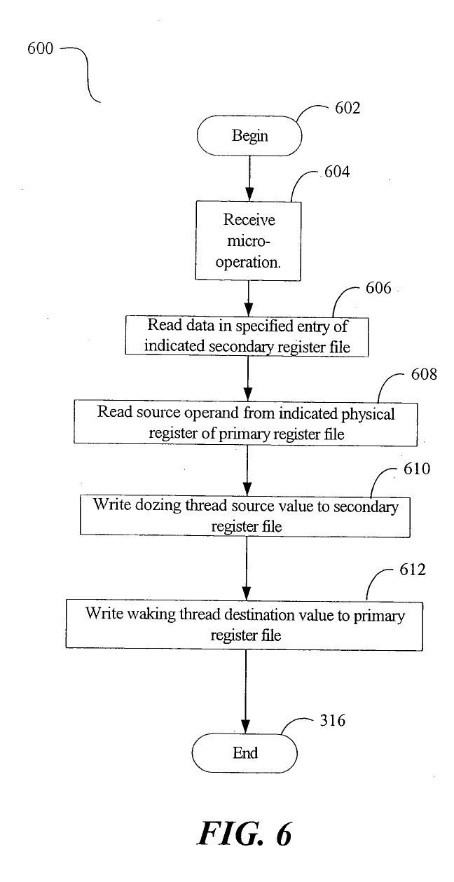

The example illustrated in Table 1 assumes that logical registers r1 through rx are subject to renaming. The term “switch_spool_op” indicates an opcode that is understood and executed by an execution unit 190 to result in the actions described below in connection with FIG. 6. It will be noted that, for at least one embodiment, the register swap micro-operation 212 specifies the same logical register as both the source and destination registers.

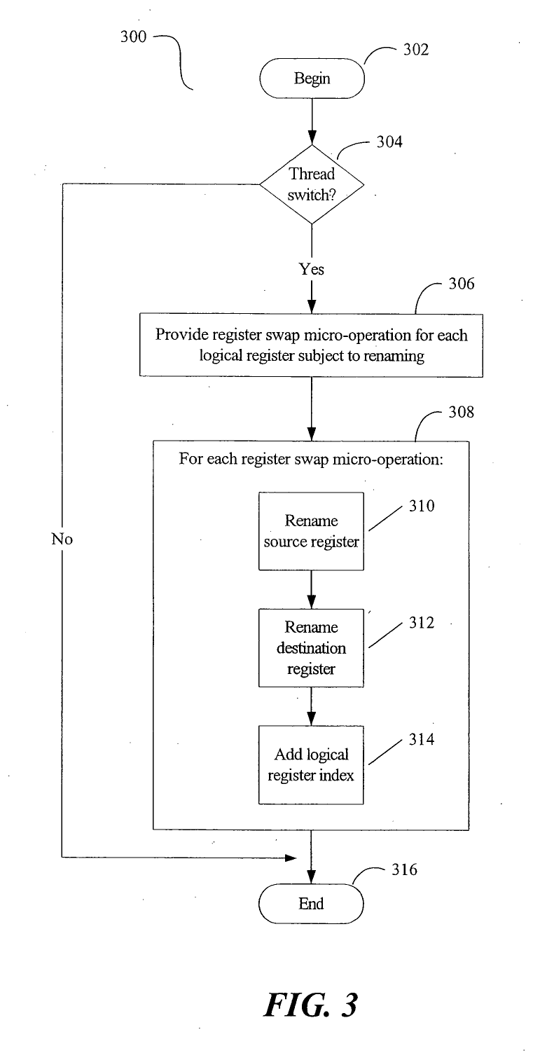

The front end 120 (FIG. 1) may generate, as is illustrated in Table 1, a register swap micro-operation 212 for each architectural logical register that is subject to renaming under the particular architectural definitions for processor 104 (FIG. 1). (For further discussion of such micro-operation generation, see discussion below of block 306, FIG. 3). Accordingly, the micro-operations 212 are forwarded, for at least one embodiment, to rename logic 140 (FIG. 1).

TABLE 1

| | | | | Secondary | |
|---|---|---|---|---|---|
| | Destination(logical) | | Source(logical) | register file | Immed. |
| Opcode | register | := | register | identifier | data |
| switch_spool_op | <r1> | : = | <r1> | 0 | none |
| switch_spool_op | <r2> | := | <r2> | 0 | none |
| . . . | . . . | := | . . . | . . . | . . . |
| switch_spool_op | <rx> | : = | <rx> | 0 | none |

The register swap micro-operations discussed above are thus provided by the front end 120. Each may constitute an instruction 145 that is renamed by rename logic 140. The register swap micro-operations 212 are thus renamed just like any other instruction. Accordingly, FIG. 2 illustrates that register swap micro-operations 212 may be forwarded to rename logic (such as, for example, rename logic 140 illustrated in FIG. 1). Thereafter, the dozing thread t0 202 becomes inactive and the waking thread t1 204 becomes the active software thread for the physical thread 230.

Although FIG. 2 illustrates that all register swap micro-operations 212 are generated during the same time frame 240, it is not necessarily so for all embodiments. That is, for at least some embodiments the register swap micro-op 212 for all logical registers subject to renaming are not generated as a block. For example, thread switch micro-ops 212 may be interleaved with other thread switch tasks, such as clearing buffers, moving non-renamed state variables, etc.

FIG. 3 is a flowchart illustrating a method 300 for generating and renaming a register swap micro-operation, such as register swap micro-operations 212 illustrated in FIG. 2. FIG. 3 illustrates that the method 300 begins at block 302 and proceeds to block 304.

At block 304, it is determined whether a thread switch operation has been triggered by a trigger event. If so, then processing proceeds to block 306. Otherwise, processing ends at block 316.

At block 306, a register swap micro-operation is provided by the front end (such as, for example, front end 120 illustrated in FIG. 1) for each logical register. For at least one embodiment, a register swap micro-operation is provided 306 for only those logical registers that are subject to renaming. While FIG. 3 illustrates that a register swap micro-operation is generated for each logical register subject to renaming at block 306, such micro-operations need not all be provided as a block. As is explained above, one or more micro-ops may be provided in an interleaved fashion with other instructions or micro-operations. Processing then proceeds to block 308.

At block 308, each register swap micro-operation that was generated at block 306 is renamed. In particular, for each of the register swap micro-operations, blocks 310, 312 and 314 are performed.

At block 310, the source operand registers are renamed to reflect the physical register (such as, for example, one of physical registers 106 in FIG. 1) from which the execution unit should retrieve the source operand. Of course, one of skill in the art will realize that, for many common renaming schemes, more than one source operand is renamed because more than one source operand is indicated in the source instruction or micro-operation. Such approach is certainly appropriate for embodiments wherein more than one source operand is specified in the micro-operations generated at block 306. For the illustrative embodiment shown in FIG. 3, however, it is assumed that the micro-operations generated at block 306 are of the single-source format illustrated in Table 1.

From block 310, processing proceeds to block 312. At block 312, the micro-operation is renamed such that a physical register is designated for the destination operand. Again, the illustrative embodiment shown in FIG. 3 assumes that a single destination register is renamed at block 312 because the micro-operation generated at block 306 indicates a single destination operand. However, other embodiments may include renaming 312 of multiple destination operands.

From block 312, processing proceeds to block, 314. At block 314, the micro-operation is modified to append a logical register index to the micro-operation. This action 314 is performed because, when the source register is renamed 310, the renamed micro-operation becomes disassociated from the original logical register designation. The execution unit may utilize the appended register index in order to locate the secondary register file 130 entry to be “swapped.” The appending 314 of a logical register index is optional. For at least one other embodiment, for example, the execution unit may consult a storage device, similar to a register alias table, that maps logical registers to the entries of the secondary register file 130 (FIG. 1).

From block 314, processing ends at block 316. A processor, such as, for example, processor 104 illustrated in FIG. 1, may perform the method 300 illustrated in FIG. 3. The generation 306 of register swap micro-operations may be performed by a front end, such as, for example, front end 120 illustrated in FIG. 1. The renaming 308 may be performed by rename logic, such as, for example, rename logic 140 illustrated in FIG. 1.

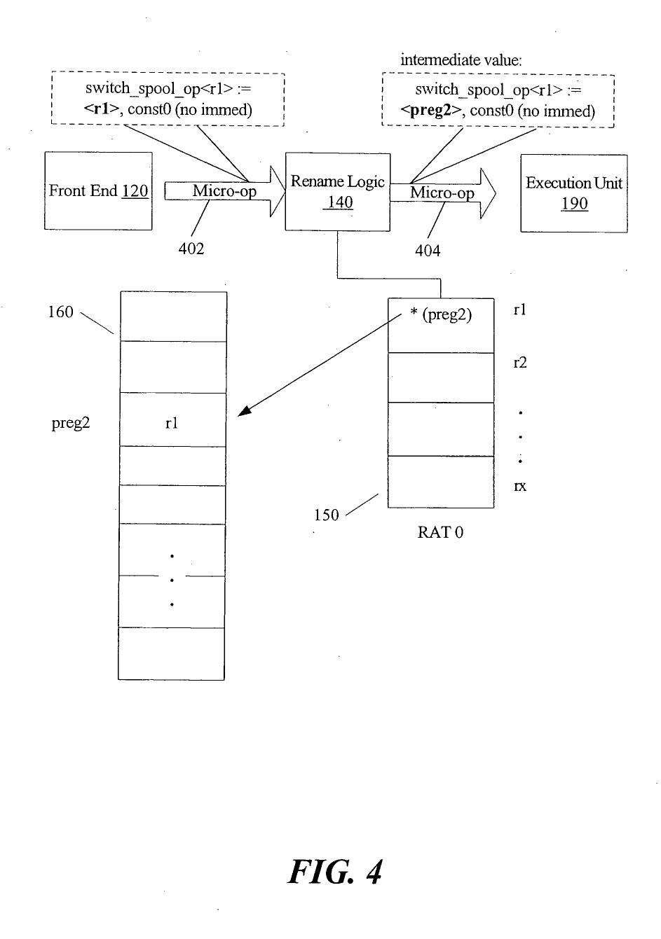

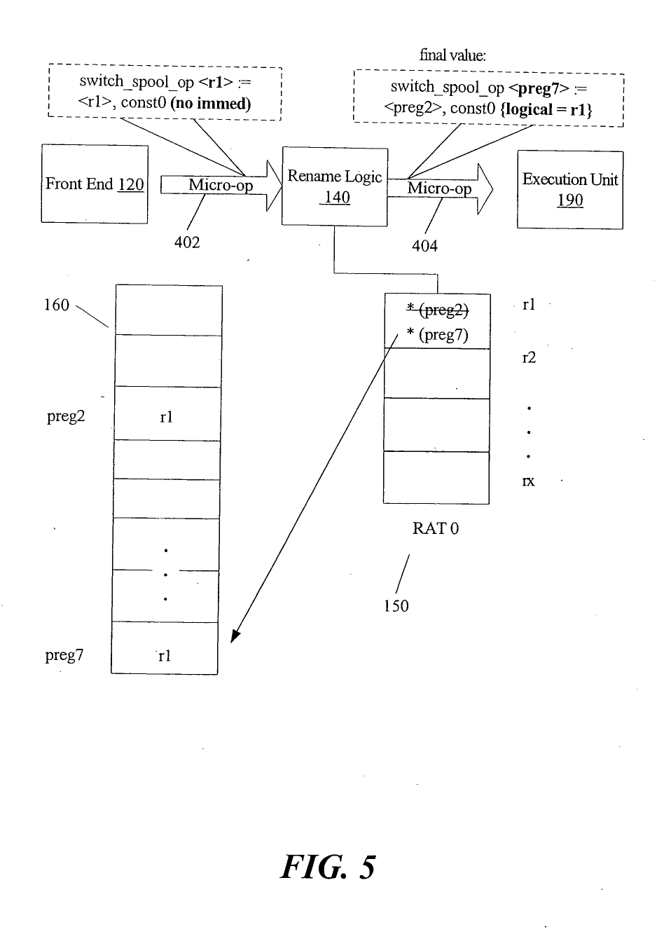

FIGS. 4 and 5 are block data flow diagrams illustrating further details of at least one embodiment of the renaming 308 (FIG. 3) of an example register swap micro-operation 402. FIGS. 4 and 5 are therefore discussed below with reference to FIG. 3.

Generally, when the micro-operation 402 is renamed 308, logical source and destination register identifiers are replaced with physical source and destination register identifiers in the renamed micro-operation 404. FIG. 4 represents an intermediate value of the renamed micro-operation 404 in order to provide a step-by-step discussion of the renaming mechanism. It will be understood that this intermediate representation is provided for purposes of illustration only.

Generally, FIGS. 4 and 5 illustrate that logical source register r1 is renamed to physical register preg2. Also, a new physical destination register, preg7, is assigned for destination register r1. In addition, the renamed micro-operation 404 may be modified to include the logical register index (r1, in this case). The following discussion of FIGS. 4 and 5 illustrate that, during the renaming process 308, a renamed micro-operation 404 is generated. Execution of the renamed micro-operation 404 effects a “swap” of the physical register file values of the dozing thread with the secondary register file values for the waking thread.

FIG. 4 illustrates that the front end 120 may provide a register swap micro-operation, 402, to rename logic 140. For purposes of example, FIG. 4 illustrates that the example register swap micro-operation 402 is of the format illustrated above in Table 1.

One of skill in the art will recognize that the format illustrated in Table 1, as well as the example micro-operation 402 illustrated in FIG. 4, are provided for purposes of example only. They should not be construed to be limiting. Various other micro-operation formats may be utilized. For example, the micro-operation 402 may include an explicit index into the secondary register file 130. Also, for example, the fields of the micro-operation 402 may appear in different order than that shown in Table 1.

FIG. 4 illustrates that the rename logic 140 consults the register alias table (RAT) 150 in order to determine the location in the register file 160 that holds the most current version of the source operand. For an embodiment that provides a separate RAT 150 for each physical thread, the RAT 150 for the physical thread on which active thread t0 (see 202, FIG. 2) is running is consulted. For at least one embodiment, the rename logic 140 uses the logical register label (r1) for the logical source register as an index into the appropriate RAT 150. Rename logic 140 may thus determine that the RAT 150 entry for r1 indicates that physical register 2 (preg2) holds the most recent value of logical register r1 for virtual thread t0. Accordingly, FIG. 4 illustrates that the renamed micro-operation 404 generated by rename logic 140 indicates that the source operand resides in preg2. Renaming 310 of the source operand register has thus been performed.

FIG. 5 is a data flow diagram illustrating further actions taken to rename 308 the illustrative register swap micro-operation 402 set forth, by way of example, in FIG. 4. FIG. 5 illustrates that rename logic 140 selects an unused physical register, preg7, to hold the destination operand. Accordingly, the RAT 150 is updated to reflect that preg7, rather than preg2, now holds the most recent value for r1. In addition, the renamed micro-operation 404 is modified to reflect that the source operand should be placed into preg7. In this manner, the destination register for the micro-operation 402 is renamed 312.

Also, FIG. 5 illustrates that the micro-operation 402 is modified 314 to include the logical register index (r1, in this case). For at least one embodiment, the logical register index is appended to the micro-operation 404. The logical register index may be appended, for example, as immediate data.

FIG. 5 thus illustrates that the final renamed micro-operation 404 has been modified to rename 310 the source register, rename 312 the destination register, and add 314 the logical register index. The renamed micro-operation 404 is forwarded to the execution unit 190 for execution.

FIG. 6 is a flowchart illustrating at least one embodiment of a method 600 for executing a renamed register swap micro-operation (such as, for example, the final renamed micro-operation 404 illustrated in FIG. 5). For at least one embodiment, the method 600 of FIG. 6 may be performed by an execution unit (such as, for example, the execution unit 190 illustrated in FIGS. 1, 4 and 5). FIG. 6 is discussed below with reference to FIGS. 3 and 5.

FIG. 6 illustrates that the method begins at block 602 and proceeds to block 604. At block 604, the renamed micro-operation 404 is received. The micro-operation 404 may be decoded in order to determine, from the switch_spool_op opcode, that a swap of values between the register file 160 and a secondary register file 130 is desired. Processing then proceeds to block 606.

At block 606, the appropriate entry (indicated by the logical register index) of the appropriate secondary register file 130 (indicated by the secondary register file identifier) is read. For at least one embodiment, this read operation provides the indicated secondary register file 130 entry value to the execution unit 190. Processing then proceeds to block 608.

At block 608, the source operand is read and retrieved from the primary register file (see, for example, 106 in FIG. 6), as would be expected for normal execution of a common micro-operation. Processing then proceeds to block 610.

At block 610, the source operand value retrieved from the primary register file 160 (which is the value of the indicated logical register for the dozing thread) is written to the appropriate entry of the secondary register file 130. In this manner, the logical register value for the dozing thread is “swapped out” of the primary register file 106 to be stored as the secondary register file 130 value for that logical register. Processing then proceeds to block 612.

At block 612, the source operand value that was retrieved from the secondary register file 130 at block 608 is placed on the result bus to be written to the primary register file 160. In this manner, the logical register value for the waking thread, which was read from the secondary register file 130 at block 606, is “swapped in” to the primary register file 160 to be stored as the current value for the indicated logical register. The register file 160 now holds, at the destination register, the current value of the logical register of interest for the waking thread. After such swap of the logical register values between the primary and secondary register files is completed at block 612, processing ends at block 614.

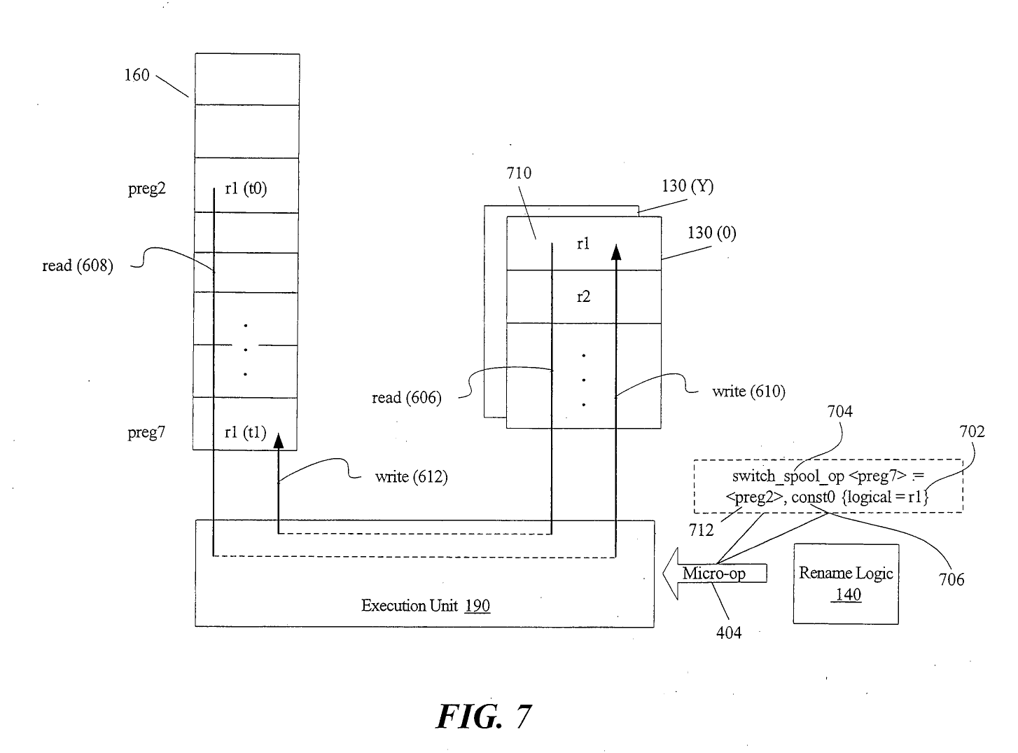

FIG. 7 is a block data flow diagram illustrating at least one embodiment of the FIG. 6 method 600 for the illustrative sample renamed micro-operation 404 discussed above in connection with FIGS. 4 and 5. FIG. 6 is referenced along with FIG. 7 in the following discussion.

FIG. 7 illustrates that the renamed micro-operation 404 is received 604 by the execution unit 109 after it has been renamed 308 (FIGS. 3-5) by rename logic 140. The execution unit 190 decodes the micro-operation to determine that the opcode 704 (“switch_spool_op”) indicates that a register swap operation is to be executed.

The execution unit 190 also utilizes the secondary register file identifier (see “secondary register file identifier” field of Table 1, above) of the register swap micro-operation 402 to determine the appropriate secondary register file 130 for the waking thread. For our example, the execution unit 190 determines that the secondary register file identifier 706 (“const0”) of the renamed micro-operation 404 indicates that a value from secondary register file 0 130(0) is to be swapped in. For at least one other embodiment, the secondary register file identifier 706 is not appended to the micro-operation. Instead, a global signal is utilized to indicate to the functional unit which thread is the waking thread. The functional unit utilizes this global signal to determine the appropriate secondary register file 130.

FIG. 7 illustrates that the execution unit 109 reads 606 the indicated entry 710 of the indicated secondary register file 130(0). The execution unit 190 may determine which entry of the secondary register file 130(0) is desired by utilizing the register index 702. Register index 702 may, for at least one embodiment, be appended (see 314, FIG. 3) as immediate data for the micro-operation 404.

For our example, the appended register index, “r1” 702, indicates that the r1 entry 710 of the secondary register file 130 is to be read 606. The value of the secondary register file indicator 706 is a constant value of zero (“const0”), indicating that secondary register file 0, 130(0), contains the logical register values of the waking thread. Accordingly, the execution unit 190 reads 606 the indicated entry 710 of the specified secondary register file 130(0). For our example, the indicated entry 710 contains the most current value of logical register r1 for the waking thread, t1 (see 204, FIG. 2).

FIG. 7 further illustrates that the execution unit 190 reads 608 the source operand from the entry of the primary register file 160 as indicated by the source register identifier 712 in the renamed micro-operation 404. For our example, the renamed micro-operation 404 indicates preg2 as the source register. Preg2 thus contains the most current value of logical register r1 for the dozing thread, to (see 202, FIG. 2).

FIG. 7 further illustrates that the execution unit 190 completes the “swap” of logical register values from the dozing and sleeping threads for the indicated logical register by performing write actions 610, 612. The term “write” as used in the discussion of method 600 is not necessarily meant to imply a write to memory. Instead, for at least one embodiment, the write actions are performed by modifying the contents of the specified secondary register file 130(0) and primary register file 160, respectively. For at least one embodiment, the execution unit 190 accomplishes the write 612 to the primary register file 160 by placing a value on the result bus. Each of the write actions 610, 612 is discussed in further detail immediately below.

FIG. 7 illustrates that the execution unit 190 writes 610 the dozing thread source value to the designated entry 710 of the specified secondary register file 130(0). That is, the thread 0 value for logical register r1, which was read 608 from the primary register file 160, is written to the designated entry 710 of the specified secondary register file 130(0). In this manner, the secondary register file 130(0) now holds the thread 0 value for r1.

Similarly, FIG. 7 illustrates that the execution unit writes 612 the waking thread value for the designated logical register (r1) to the primary register file 160 at the entry indicated as the destination register 714 (preg7). Thus, for our example, the execution unit 190 writes the thread 1 value for logical register r1, which has been read 606 from the specified secondary register file 130(0), to preg7 in the primary register file 160. As is indicated above, for at least one embodiment, the execution unit 190 performs this write action 612 by placing the thread 1 value for logical register r1 on a result bus.

In summary, the discussion above discloses embodiments of a processor and methods for utilizing secondary register files to maintain register values for inactive virtual threads. According to at least some of the disclosed embodiments, register values for each of a plurality of active virtual threads are maintained in a primary register file 160, while register values for inactive threads are maintained in separate secondary register files. All registers of the primary register file 160 are available to rename logic 140. By maintaining register values for inactive threads in a secondary register file, more entries of the primary register file 160 are available for renaming of logical registers for active threads.

While the secondary register file 130 embodiments disclosed herein may be practiced to maintain and swap active and inactive state element values for a plurality (N) of SoEMT software threads on a single physical thread, for at least one embodiment the number of physical threads is greater than one (M≧2).

One of skill in the art will also recognize that blocks 606, 608, 610 and 612 need not necessarily be performed in the order illustrated. Indeed, any alternative ordering of the illustrated processing may be utilized, as long as it achieves the functionality illustrated in FIG. 6.

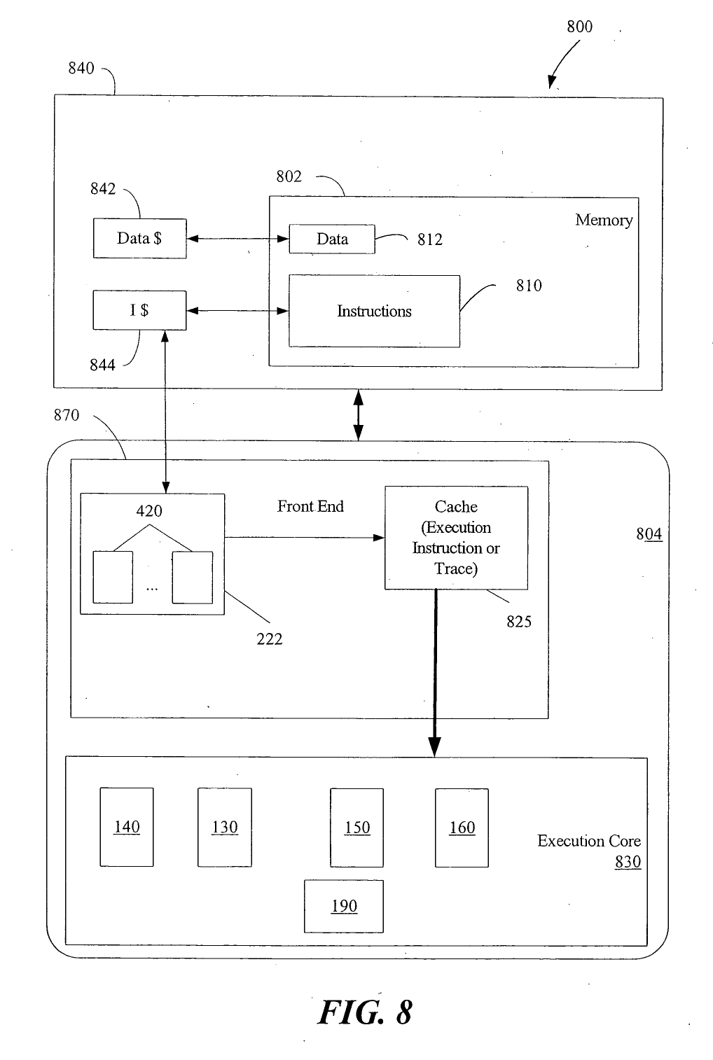

FIG. 8 is a block diagram illustrating at least one embodiment of a computing system 800 capable of performing the disclosed techniques to maintain general register values for active and inactive virtual threads. The computing system 800 includes a processor 804 and a memory 802. Memory 802 may store instructions 810 and data 812 for controlling the operation of the processor 804.

Memory 802 is intended as a generalized representation of memory and may include a variety of forms of memory, such as a hard drive, CD-ROM, random access memory (RAM), dynamic random access memory (DRAM), static random access memory (SRAM), flash memory and related circuitry. Memory 802 may store instructions 810 and/or data 812 represented by data signals that may be executed by processor 804. The instructions 810 and/or data 812 may include code for performing any or all of the techniques discussed herein.

The processor 804 may include a front end 870 along the lines of front end 120 described above in connection with FIG. 1. For at least one embodiment, front end 870 provides register swap micro-operations to an execution core 830.

Front end 870 also supplies other instruction information to the execution core 830 and may include a fetch/decode unit 222 that includes M logically independent sequencers 420. For at least one embodiment, the front end 870 prefetches instructions that are likely to be executed. For at least one embodiment, the front end 870 may supply the instruction information to the execution core 830 in program order.

For at least one embodiment, the execution core 830 prepares instructions for execution, executes the instructions, and retires the executed instructions. The execution core 830 may include out-of-order logic (not shown) to schedule the instructions for out-of-order execution. The execution core 830 may also include one or more execution units 190 to perform the execution of instructions (as used herein, the term “instructions” includes micro-operations). The execution core 830 may also include a primary register file 160, secondary register files 130, rename logic 140 and one or more register alias tables 150, all of which are discussed above in connection with FIG. 1.

The execution core 830 may include retirement logic (not shown) that reorders the instructions, executed in an out-of-order manner, back to the original program order. This retirement logic receives the completion status of the executed instructions from the execution Unit(s) 190 and processes the results so that the proper architectural state is committed (or retired) according to the program order.

As used herein, the term “instruction information” is meant to refer to basic units of work that can be understood and executed by the execution core 830. Instruction information may be stored in a cache 825. The cache 825 may be implemented as an execution instruction cache or an execution trace cache. For embodiments that utilize an execution instruction cache, “instruction information” includes instructions that have been fetched from an instruction cache and decoded. For embodiments that utilize a trace cache, the term “instruction information” includes traces of decoded micro-operations. For embodiments that utilize neither an execution instruction cache nor trace cache, “instruction information” also includes raw bytes for instructions that may be stored in an instruction cache (such as I-cache 844).

The processing system 800 includes a memory subsystem 840 that may include one or more caches 842, 844 along with the memory 802. Although not pictured as such in FIG. 8, one skilled in the art will realize that all or part of one or both of caches 842, 844 may be physically implemented as on-die caches local to the processor 804. The memory subsystem 840 may be implemented as a memory hierarchy and may also include an interconnect (such as a bus or point-to-point interconnect) and related control logic in order to facilitate the transfer of information from memory 802 to the hierarchy levels. One skilled in the art will recognize that various configurations for a memory hierarchy may be employed, including non-inclusive hierarchy configurations.

The foregoing discussion describes selected embodiments of methods, systems and apparatuses to maintain architectural register values for a plurality of virtual software threads within a processor. For purposes of explanation, specific numbers, examples, systems and configurations were set forth in order to provide a more thorough understanding. However, it is apparent to one skilled in the art that the described method and apparatus may be practiced without the specific details. In other instances, well-known features were omitted or simplified in order not to obscure the method and apparatus.

Embodiments of the method may be implemented in hardware, hardware emulation software, firmware, or a combination of such implementation approaches. Embodiments of the invention may be implemented for a programmable system comprising at least one processor, a data storage system (including volatile and non-volatile memory and/or storage elements), at least one input device, and at least one output device. For purposes of this application, a processing system includes any system that has a processor, such as, for example; a digital signal processor (DSP), a microcontroller, an application specific integrated circuit (ASIC), or a microprocessor.

A program may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

At least one embodiment of an example of such a processing system is shown in FIG. 8. Sample system 800 may be used, for example, to execute embodiments of a method 300 for generating and renaming registers swap micro-operations and a method 600 for executing such micro-operations. More generally, sample system 800 may be used to maintain register values for one or more inactive virtual software threads in secondary register files, such as the embodiments described herein. Sample system 800 is representative of processing systems based on the Pentium®, Pentium® Pro, Pentium® II, Pentium® III, Pentium® 4, and Itanium® and Itanium® II microprocessors available from Intel Corporation, although other systems (including personal computers (PCs) having other microprocessors, engineering workstations, personal digital assistants and other hand-held devices, set-top boxes and the like) may also be used. For one embodiment, sample system may execute a version of the Windows® operating system available from Microsoft Corporation, although other operating systems and graphical user interfaces, for example, may also be used.

While particular embodiments of the present invention have been shown and described, it will be obvious to those skilled in the art that changes and modifications can be made without departing from the present invention in its broader aspects.

For example, although the foregoing discussion focuses, for purposes of illustration, on embodiments for which only general purpose architectural register values are maintained in secondary register files 130, one of skill in the art will recognize that other embodiments may be fashioned to maintain the values of other types of registers, such as control registers, predicate registers, and the like.

Accordingly, one of skill in the art will recognize that changes and modifications can be made without departing from the present invention in its broader aspects. The appended claims are to encompass within their scope all such changes and modifications that fall within the true scope of the present invention.

1. An apparatus comprising:
M physical threads to support N switch-on-event software threads, wherein n>m>1;
a primary storage area to store a first value associated with a logical register for a first virtual thread;
a secondary storage area to store a second value associated with said logical register for a second virtual thread; and
an execution unit to, responsive to a swap instruction, write the first value to the secondary storage area and to write the second value to the primary storage area:

2. The apparatus of claim 1, wherein:
the first virtual thread is a dozing active virtual thread on a selected one of the M physical threads; and
the second virtual thread is a waking inactive virtual thread for the selected physical thread.

3. The apparatus of claim 1, wherein:
the primary storage area is a register file.

4. The apparatus of claim 1, wherein:
the secondary storage area is a register file to store values for a plurality of general purpose logical registers, where said values are associated with an inactive software thread.

5. The apparatus of claim 1, further comprising:
rename logic to designate a portion of the primary storage area for the first value.

6. The apparatus of claim 1, wherein:
the control logic is further to generate, responsive to the trigger event, a swap instruction for each of a plurality of logical registers.

7. The apparatus of claim 5, wherein:
said rename logic is further to modify the swap instruction to provide an identifier to indicate the logical register.

8. The apparatus of claim 1, further comprising:
a plurality of secondary register files.

9. The apparatus of claim 8, further comprising:
N−M secondary register files.

10. A method, comprising:
generating a register swap instruction that indicates a logical register as source and destination registers;
renaming the logical source register to a first physical register;
renaming the logical destination register to a second physical register; and
generating a modified register swap instruction that indicates the first physical register, the second physical register, and an identifier that indicates the logical register.

11. The method of claim 10, wherein renaming the logical source register further comprises:
consulting a map table to identify the first physical register.

12. The method of claim 10, wherein generating the register swap instruction further comprises:
including in the register swap instruction a swap opcode, wherein the swap opcode is to indicate to a functional unit that a swap of register values between a primary storage area and a secondary storage area is to be performed.

13. The method of claim 10, wherein generating the register swap instruction further comprises:
including in the register swap instruction a secondary register file identifier to indicate a secondary storage area associated with a waking software thread.

14. The method of claim 10, wherein:
generating said register swap instruction is performed responsive to a thread switch trigger event.

15. The method of claim 10, wherein:
generating said register swap instruction is performed to facilitate a switch from an active software thread to an inactive software thread on one of a plurality of physical threads.

16. The method of claim 10, wherein generating a register swap instruction further comprises:
generating a register swap micro-instruction .

17. The method of claim 14, wherein:
the thread switch trigger event is expiration of a time-multiplex timer.

18. The method of claim 14, wherein:
the thread switch trigger event is a cache miss.

19. A method, comprising:
receiving a register swap instruction;
reading a first register value for a logical register from a primary register file;
reading a second register value for the logical register from a secondary register file; and
swapping the first and second register values.

20. The method of claim 19, wherein:
the first register value is associated with software thread that is currently active on a physical thread; and
the second register value is associated with an inactive software thread that is to become active on the physical thread.

21. The method of claim 19, wherein swapping the first and second register values further comprises:
writing the second register value to a result bus.

22. The method of claim 19, wherein swapping the first and second register values further comprises:
writing the second register value to the primary storage area.

23. The method of claim 19, wherein swapping the first and second register values further comprises:
writing the first register value to the secondary storage area.

24. The method of claim 23, wherein writing the first register value to the secondary storage area further comprises:
writing the first register value to a location in the secondary storage area that corresponds to the logical register.

25. The method of claim 22, wherein writing the second register value to the primary storage area further comprises:
writing the second register value to a location in the primary storage area that has been designated for the logical register.

26. A system, comprising:
a memory system; and
a multithreaded processor to support N software threads;
wherein the processor includes a primary storage area to store register values for each of M active software threads;
wherein the processor further includes a secondary storage area to store register values for an inactive software thread.

27. The system of claim 18, further comprising:
N−M secondary storage areas, each of the secondary storage areas to store register values for one of N−M inactive software threads.

28. The system of claim 18, wherein:
said primary storage area further comprises a register file that includes a plurality of physical registers.

29. The system of claim 20, further comprising:
rename logic to assign one of the physical registers to a destination operand associated with one of the M active threads.

30. The system of claim 21, further comprising:
a rename map table to map a logical register to the assigned physical register.

31. The system of claim 18, wherein the processor further comprises:
control logic to trigger a swap of register values between the primary storage area and the secondary storage area responsive to a thread switch trigger event.

32. The system of claim 18, wherein the processor further comprises:
an execution unit to perform a swap of register values between the primary storage area and the secondary storage area.

33. The system of claim 18, wherein:
said control logic is further to generate an instruction to trigger the swap.
